(19) United States
(12) Patent Application Publication
(10) Pub. No.: US 2013/0147133 A1
(43) Pub. Date: Jun. 13, 2013

(54) POWER-OPERATED CHUCK FOR A TOOL SPINDLE OF A MACHINE TOOL

(71) Applicant: Bodo Kaleja, Ratingen (DE)

(72) Inventor: Bodo Kaleja, Ratingen (DE)

(73) Assignee: ILLINIOIS TOOL WORKS INC., Glenview, IL (US)

(21) Appl. No.: 13/811,737

(22) PCT Filed: Jul. 25, 2011
(86) PCT No.: PCT/US11/45221

§ 371 Date: Feb. 24, 2013

(30) Foreign Application Priority Data
Jul. 26, 2010 (DE) 102010032298.9
Aug. 20, 2010 (DE) 102010039608.7

(51) Int. Cl. B23B 31/16

(52) U.S. Cl. CPC B23B 31/16
USPC 279/126

(57) ABSTRACT

A power-operated chuck for a tool spindle of a machine tool includes a chuck body and at least one chucking device which is guided in a radial guide of the chuck body and which, for exerting a desired chucking force on a workpiece chucked in the chuck, can be adjusted relative to the chuck body by a chucking-force generator via at least one drive member arranged in the chuck body. At least one chucking device has a measuring device for measuring a chucking force exerted by the chucking device on the workpiece chucked in the chuck and an evaluating device for evaluating the chucking force measured by the measuring device.

The invention relates to a power-operated chuck for a tool spindle of a machine tool, in particular a lathe.

In particular, the invention relates to a power-operated chuck which has a chuck body and at least one chucking device guided in a radial guide of the chuck body. The at least one chucking device can be adjusted relative to the chuck body by a chucking-force generator via at least one drive member arranged in the chuck body in order to exert a predeterminable chucking force on a workpiece chucked in the chuck.

The term “chucking device” used herein refers in principle to the component/components of the chuck which can be moved in the radial direction relative to the chuck for exerting a chucking force on a workpiece chucked in the chuck. For example, the chucking device can be embodied as a chuck jaw or as a top jaw having a chuck jaw which is screwed thereto or can be fastened thereto in a different way.

Furthermore, the term “chuck” used herein generally refers to a rotating chucking fixture of a machine tool for machining a workpiece. This includes conventional chucks, which are designed, for example, for chucking round or regularly shaped triangular and hexagonal workpieces in three chuck jaws or geometrically accurate round and square or octagonal workpieces in four chuck jaws (four-jaw chucks), or compensating chucks. Of course, special forms which have two chuck jaws or more than four chuck jaws can be subsumed under the term “chuck” used herein. As a rule, the chuck jaws move uniformly in the radial direction, i.e. in the direction of the axis of rotation, when the chuck is tightened.

It is generally known that higher centrifugal forces act on the chuck jaws of a rotating chuck with increasing spindle speed. These centrifugal forces acting on the chuck jaws reduce the chucking force exerted by the chuck jaws on a workpiece chucked in the chuck.

In order to therefore ensure a sufficient chucking force even at high spindle speeds, it is conceivable to already generate such a high chucking force when the spindle is stopped, i.e. when the chuck is not rotating, that sufficient chucking force still remains despite the force reduction caused by the centrifugal forces at high spindle speeds.

However, such an increase in the chucking force when the spindle is stopped entails the risk of undesirable deformations of the chucked workpiece, in particular if the workpieces are prone to deformations, such as, for example, thin-walled workpieces. With such workpieces which are prone to deformations, it may therefore be necessary to reduce the chucking force applied to the workpiece by the chuck jaws. However, this may possibly lead to the chucking force being reduced to an inadmissibly high degree at high spindle speeds, which increases the risk of accidents.

In order to avoid this disadvantage, a power-operated chuck of the type mentioned at the beginning is proposed in document DE 2 150 885 B1, in which chuck the chucking force can be controlled according to the speed of the tool spindle in order to be able to vary the chucking force exerted on a workpiece chucked by the chuck jaws of the chuck and adapt it to the respective operating conditions. In particular, the chucking force exerted on a workpiece by the chuck jaws is varied by suitable activation of a chucking-force generator. The chucking-force generator generates a predetermined or predeterminable chucking force which is transmitted pneumatically or hydraulically to a drive member arranged in the chuck body and from there to the chuck jaws, which can be adjusted radially relative to the chuck body.

A disadvantage with this known design can be seen in the fact that, when the chucking force generated by the chucking-force generator and transmitted to the chuck jaws is changed, neither the lubricating state nor the rigidity of the chuck and the respective workpiece is taken into account. However, these boundary conditions can crucially affect the actual chucking force profile, i.e. the chucking forces actually exerted on the workpiece by the chuck jaws, to such an extent that the results determined in advance deviate decisively from the actual chucking force profile, because it is not the actual chucking force profile that is changed, but rather only the force entering the chuck.

In the monitoring of the working sequence of machine tools, in particular when machining metals by means of lathes, effective monitoring of the holding forces of the chuck during the machining operation has hitherto been absent. The safety of the chucking operation and monitoring of the holding forces of the chuck are absolutely necessary, in particular on account of the progressive refinement in machining technology and at high cutting capacities.

High cutting capacities require a high chucking force of the chucking fixture, which can only be achieved with well-lubricated chucking fixtures. For the safety of the machining operation, the operating state of the chucking fixture therefore has to be constantly monitored, because physical, tribological and chemical influences can lead to a rapid decrease in the chucking forces of the chucking fixture. This problem is largely underestimated in practice, because the drop in the chucking force during the machining operation has not been recognized hitherto. This problem was also less important under the earlier normal cutting conditions with lower cutting capacities; however, since machining is carried out at a high cutting capacity with advanced numerically controlled machine tools and with the use of modern cutting materials, the safety risk as a result of insufficiently high chucking forces of the chuck on machine tools has increased disproportionately without this having been recognized hitherto to an adequate degree.

A device for measuring a chucking force exerted on a chucked workpiece by a chuck is known from document EP 0 074 524 A1. The device known from this prior art is placed, when the spindle is stopped, against those locations of the chuck jaws which are used subsequently for holding the workpieces, i.e. during the actual machining of the workpieces and during spindle operation. In this way, realistic measured values of the chucking force can be obtained, because the measured state of the chucking device corresponds to the subsequent operating state.

The disadvantage with this known device for measuring the chucking force consists in the fact that the measuring of the chucking force is relatively complicated, since the workpiece has to be removed from the chuck and the chucking-force measuring device has to be chucked. The result of this is that measurements of the chucking force are often only made irregularly in practice. The comparison required per se between the respective measured values (actual values) and a predetermined limit value (set point), with which the holding force is to be prevented from falling below the value required for a safe machining operation, is therefore not done with the necessary regularity.

On the basis of this statement of the problem, the object of the invention is to develop a power-operated chuck of the type mentioned at the beginning to the effect that it can be ensured, in a manner which is simple to realize but is nonetheless effective, that a machining operation is carried out only under the predetermined conditions. In particular, a power-operated chuck with which the holding forces of the chuck jaws can be monitored during the machining operations is to be specified. Since the holding force actually exerted on a chucked workpiece by the chuck jaws drops with the number of chucking operations, because the sliding relationships at the highly loaded transition surfaces of the mechanisms used for transmitting the chucking force deteriorate between the lubricating operations, the invention serves in particular to maintain the necessary chucking force by timely and proper lubrication of the chuck.

To achieve the aforesaid object, a power-operated chuck for a tool spindle of a machine tool, in particular a lathe, which has the features of independent claim 1 is specified.

Accordingly, a power-operated chuck is proposed which has a chuck body and at least one chucking device guided in a radial guide of the chuck body, wherein this at least one chucking device can be adjusted relative to the chuck body by a chucking-force generator via at least one drive member arranged in the chuck body in order to exert a chucking force (desired chucking force) on a workpiece chucked in the chuck. According to the invention, the at least one chucking device has a measuring device for measuring a chucking force exerted by the chucking device on the workpiece chucked in the chuck. Furthermore, an evaluating device for evaluating the chucking force measured by the measuring device is provided.

The advantages which can be achieved with the solution according to the invention are obvious: owing to the fact that the at least one chucking device of the power-operated chuck has a measuring device, it is possible for the instantaneous chucking force (actual chucking force) exerted on the workpiece by the at least one chucking device to be determined continuously or at predetermined times and/or during predetermined events, i.e. even when the spindle is rotating. These measured values, determined by means of the measuring device, of the chucking force actually exerted on the chucked workpiece are evaluated in the evaluating device, which is likewise part of the at least one chucking device. This evaluation carried out by the evaluating device includes in particular an actual value/set point comparison, such that a deviation of the chucking force exerted on the workpiece by the at least one chucking device from a predetermined chucking force can be automatically determined. The detection of the actual chucking force and the subsequent evaluation of the detected actual values take place within the chucking device. It is therefore not necessary, for this purpose, for the workpiece to be removed from the chuck and for a special chucking-force measuring device to be chucked. The measurements and the monitoring of the chucking force which are required for safe operation can therefore be effected automatically and continuously, specifically without additional effort on the part of the operator. The same also applies to the requisite comparison between the respective measured values (actual values) and a predetermined limit value (set point), since the set point(s) can be filed in the evaluating device.

Advantageous developments of the invention are specified in the dependent claims.

Thus, it is advantageous if the evaluating device is preferably interchangeably accommodated as a modular subassembly in a recess formed in the at least one chucking device. Accordingly, the design of the chuck and in particular of the chuck body and the design of the radial guide of the chuck body can remain unchanged. In order to embody a chucking device according to the teachings of the present invention, it is merely necessary to provide a recess in the chucking device, the evaluating device being inserted as a modular subassembly into this recess.

It is especially preferred in the last-mentioned embodiment of the invention that the recess is formed in a side face of the chucking device, said side face being opposite the chucking surface, coming to bear against the workpiece, of the chucking device. In this way, the at least one chucking device can be provided with the evaluating device without this influencing the functionality of the at least one chucking device. Furthermore, during spindle operation, lubricants or coolants can be effectively prevented from being forced into the recess on account of the centrifugal force. However, it is of course also conceivable for the recess to be provided in a side face which is adjacent to that chucking surface of the chucking device which comes to bear against the workpiece.

In order to ensure that the measured data evaluated in the evaluating device can be transmitted to a stationary receiver, provision is made in a preferred realization of the solution according to the invention for the evaluating device to have an interface for transmitting data between the evaluating device and an external device, preferably an external hand-held device. It is conceivable in this case, for example, for the interface to be a wired interface for transmitting data between the evaluating device and the external device when the spindle is stopped. Alternatively, however, it is of course also possible for the interface to be embodied as a wireless interface, in particular as a radio interface or as an optical or electro-optical interface, such that data can be transmitted between the evaluating device and the external device both when the spindle is stopped and during spindle operation.

It should be noted in this case that a bidirectional data transmission is meant by the term “data transmission” used herein. In particular, data can also be transmitted from the external device to the evaluating device via the interface of the evaluating device. For example, it is conceivable for the set point(s) required for the actual value/set point comparison to be transmitted by the external device.

In a preferred realization of the solution according to the invention, the evaluating device has a first memory or a memory having a first memory area for storing at least one desired chucking force required for carrying out a chucking operation which is established or can be established beforehand. The term “desired chucking force” or “set point of the chucking force” used herein refers to a desired chucking force where the aim is for the actual chucking force value (actual value of the chucking force) to be the same as this theoretical set point.

The evaluating device should preferably be provided with a microprocessor in order to be able to compare the actual chucking force measured by the measuring device with the at least one desired chucking force filed in the memory. However, other solutions are of course also suitable for evaluating the measured values.

It is apparent to a person skilled in the art that it is advantageous if internal tolerance specifications for a top and a bottom control set point are preselected for the respective set points filed in the memory.

In a preferred development of the solution according to the invention, an additional memory or a further memory area is provided in order to store or store temporarily the chucking forces (actual values) measured, for example, continuously or at predetermined times or during predetermined events by the measuring device. From these measured values, the trend of the chucking force profile over the number of chucking operations can be determined by means of the evaluating device. The evaluating device, while taking into account the measured chucking force, is preferably designed for making a prognosis which predicts the number of chucking operations until the point at which the chucking force drops below the desired chucking force.

The measuring device has at least one measuring sensor for the chucking force, said measuring sensor being arranged on the at least one chucking device in a frictional connection between the chuck body and the chucking surface, coming to bear against the workpiece, of the chucking device. It is especially advantageous in this case if the measuring sensor is designed as a measuring sensor which detects the change in length, caused by the chucking force, of one of the members transmitting the chucking force. It is also conceivable in principle to determine both the chucking force and a travel adjustment of the chucking device by a measuring sensor. The measuring sensor can be formed by a strain gage, which in particular is therefore advantageous since the detection in the present case concerns small changes in length (within the μm range).

However, it is also possible for the measuring sensor to be formed directly as a force sensor. The force sensor can then expediently be formed by a quartz crystal. Finally, it can also be advantageous if the measuring sensor for the chucking force is designed as a pressure sensor. In each case, for simpler further processing of the measured values, it is advantageous if the measuring sensor changes its electrical conductivity and/or its capacitance under the effect of the chucking force and/or the travel adjustment.

In an embodiment which is especially favorable and is therefore within the scope of the invention, the measuring sensor for the chucking force is arranged on the chucking device. As a result, the measuring sensor actually detects only the chucking forces which are effective on the chucking device. The measuring result is therefore not impaired by losses of chucking force in the line of force from the drive member to the chucking device. To this end, it is advisable in particular to arrange the measuring sensor for the chucking force in the front chuck jaw part having the chucking surface.

As already explained above, it is an advantage of the invention that not only is the chucking force that is actually effective detected continuously by means of the measuring device but that the detected measured values are evaluated in the chucking device by means of the evaluating device. To this end, it is advantageous if the measuring device and/or the evaluating device has a transducer for converting the physical parameter measured with the at least one measuring sensor into a chucking force and for storing the converted chucking force as an actual chucking force in at least one memory.

It is advisable if the electrical energy required for the operation of the measuring device and/or the evaluating device is transmitted in a non-contact manner (electro-optically) from an energy source that is stationary relative to the chuck. To this end, it is conceivable, for example, to provide a pair of induction coils with which non-contact transmission of energy can be realized.

Finally, it is also advantageous if the at least one chucking device also has an identifier device for the clear identification of the chucking device.

An embodiment of the chuck according to the invention is described in more detail below with reference to the attached drawings, in which

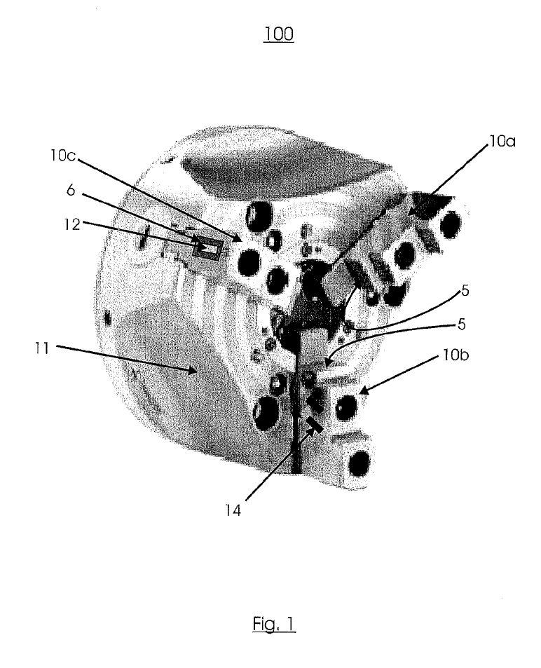

FIG. 1 shows a plan view of a power-operated chuck according to an embodiment of the invention; and

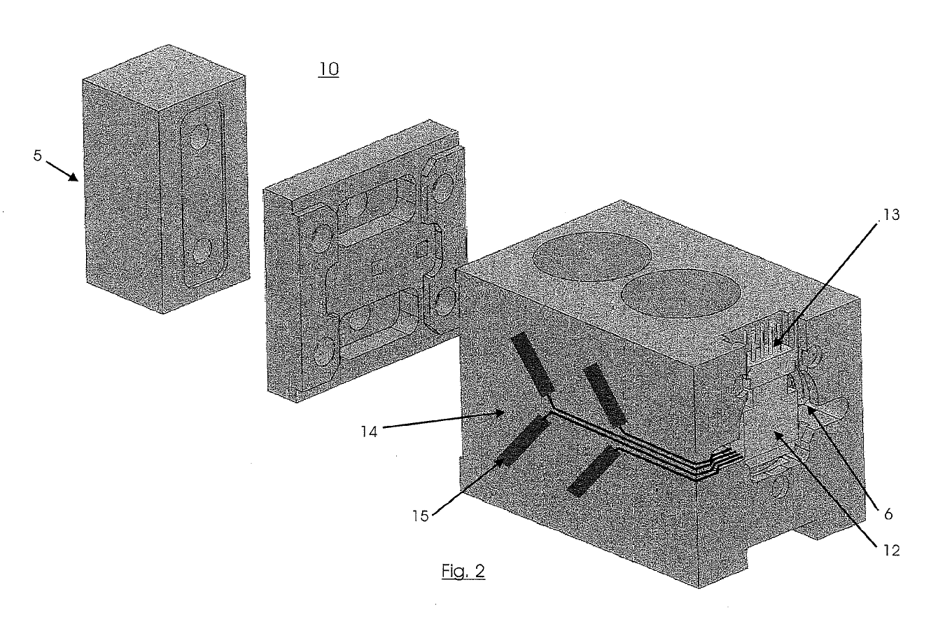

FIG. 2 shows a perspective view of a top jaw for a chuck according to the present invention.

The chuck 100 shown in FIG. 1 as an exemplary embodiment has a chuck body 11 in which three chucking devices 10a-c are guided in a radially displaceable manner in jaw guides 9. For this purpose, a plurality of guide grooves are provided on those side faces of the jaw guides 9 which are opposite one another, and a plurality of guide strips formed complementary to said guide grooves are provided on the side faces of the chucking devices 10a-c, said guide strips interacting with the guide grooves in a positive-locking manner. The chucking devices 10a-c are radially adjusted by a chucking piston which is axially displaceable in a bore of the chuck body 11.

To accommodate workpieces to be machined, the chucking piston arranged in a bore of the chuck body 11 has a central through-bore.

Each chucking device 10a-c, which is designed as a stepped jaw in the exemplary embodiment shown in FIG. 1, can have a measuring and evaluating device, as will subsequently be described in more detail with reference to the illustration in FIG. 2. The measuring/evaluating device is preferably interchangeably accommodated as a modular subassembly in a recess formed in the corresponding chucking device.

Reference is made in this respect to FIG. 2, which shows a perspective view of a chucking device 10, which, in contrast to the chucking devices (stepped jaws) used in the embodiment shown in FIG. 1, has a top jaw 8 and a chuck jaw 7 screwed thereto.

As can be seen in particular from the illustration in FIG. 2, a recess 6 is formed in a side face of the top jaw 8 belonging to the chucking device, said side face being opposite the chucking surface 5, coming to bear against the workpiece, of the chuck jaw 7 detachably fastened to the top jaw 8.

The evaluating device 12 accommodated in the recess 6 of the top jaw 8 and designed as a modular subassembly has an interface 13 for transmitting data between the evaluating device 12 and an external device not explicitly shown in FIG. 2. In particular, in the embodiment shown, the interface 13 is embodied as a wired interface, via which data can be transmitted between the evaluating device 12 and the external device, preferably designed as a hand-held device, when the spindle is stopped. It is of course also conceivable, however, for the interface 13 embodied as a wired interface in FIG. 2 to be designed for being able to also transmit data between the evaluating device 12 and the external device during spindle operation. In this case, it is advantageous if the interface 13 is embodied as a wireless interface, in particular as a radio interface or as an optical or electro-optical interface.

Although it cannot be seen explicitly in FIG. 2, the evaluating device 12, in the embodiment shown, has a memory having a first memory area for storing at least one desired chucking force required for carrying out a chucking operation which is established or can be established beforehand. This set point of the chucking force has been transmitted beforehand to the evaluating device 12 via the interface 13. Furthermore, the evaluating device 12 has a microprocessor for comparing the chucking force measured by the measuring device 14 with the at least one desired chucking force filed in the memory.

Nonetheless, the memory belonging to the evaluating device 12 has a second memory area for storing the chucking forces preferably measured continuously or at predetermined times or during predetermined events by the measuring device 14.

While taking into account the chucking forces measured preferably continuously or at predetermined times or during predetermined events, the microprocessor belonging to the evaluating device 12 is designed for making a prognosis which predicts the number of chucking operations until the point at which the chucking force drops below the desired chucking force.

As indicated in FIG. 2, the measuring device 14 has at least one chucking-force measuring sensor 15 which is arranged on the top jaw 8 of the chucking device 10 in a frictional connection between the chuck body 11 and the chucking surface 5, coming to bear against the workpiece, of the chuck jaw 7 detachably fastened to the top jaw 8. The chucking-force measuring sensor 15 can be designed as a measuring sensor which detects the change in length, caused by the chucking force, of the top jaw 8 transmitting the chucking force to the chuck jaw 7 and/or as a measuring sensor which detects the adjusting travel of the chucking device 10 (top jaw 8 with chuck jaw 7 detachably fastened thereto) in the chuck body 11.

In particular, in the embodiment shown in FIG. 2, the measuring sensor 15 is formed by a strain gage suitably arranged on the top jaw 8.

Alternatively or additionally, however, it is of course also conceivable for the chucking-force measuring sensor 15 to be designed as a force sensor, it then being preferred if the force sensor has a quartz crystal.

Although it cannot be seen explicitly from the illustration in FIG. 2, the measuring device 14, in the embodiment shown, has a transducer with which the physical parameter measured with the at least one measuring sensor is converted into a chucking force. These values converted by the transducer are then filed as actual values of the chucking force in the abovementioned memory of the evaluating device 12.

The invention is not restricted to the embodiments described with reference to the attached drawings but rather emerges when all the features disclosed herein are viewed together.

1. Power-operated chuck for a tool spindle of a machine tool, in particular a lathe, comprising a chuck body and at least one chucking device which is guided in a radial guide of the chuck body and which, for exerting a desired chucking force on a workpiece chucked in the chuck, can be adjusted relative to the chuck body by a chucking-force generator via at least one drive member arranged in the chuck body, wherein the at least one chucking device has a measuring device for measuring a chucking force exerted by the chucking device on the workpiece chucked in the chuck and an evaluating device for evaluating the chucking force measured by the measuring device.

2. Chuck according to claim 1,
wherein the evaluating device is preferably interchangeably accommodated as a modular subassembly in a recess formed in the at least one chucking device.

3. Chuck according to claim 2,
wherein the recess is formed in a side face of the chucking device, said side face being opposite the chucking surface, coming to bear against the workpiece, of the chucking device.

4. Chuck according to claim 1,
wherein the evaluating device has an interface for transmitting data between the evaluating device and an external device, preferably an external hand-held device.

5. Chuck according to claim 4,
wherein the interface is a wired interface for transmitting data between the evaluating device and the external device when the spindle is stopped.

6. Chuck according to claim 4,
wherein the interface is a wireless interface, in particular a radio interface or an optical or electro-optical interface, for transmitting data between the evaluating device and the external device when the spindle is stopped or during spindle operation.

7. Chuck according to claim 1,
wherein the evaluating device has a first memory or a memory having a first memory area for storing at least one desired chucking force required for carrying out a chucking operation which is established or can be established beforehand, and
wherein the evaluating device furthermore has a microprocessor for comparing the chucking force measured by the measuring device with the at least one desired chucking force filed in the memory.

8. Chuck according to claim 1,
wherein the evaluating device has a second memory or a memory having a second memory area for storing the chucking forces preferably measured continuously or at predetermined times or during predetermined events by the measuring device.

9. Chuck according to claim 8,
wherein the evaluating device, while taking into account the chucking forces measured preferably continuously or at predetermined times or during predetermined events, is designed for making a prognosis which predicts the number of chucking operations until the point at which the chucking force drops below the desired chucking force.

10. Chuck according to claim 1,
wherein the measuring device has at least one chuck-force measuring sensor which is arranged on the at least one chucking device in a frictional connection between the chuck body and the chucking surface, coming to bear against the workpiece, of the chucking device.

11. Chuck according to claim 10,
wherein the chucking-force measuring sensor is designed for sensing a change in length, caused by the chucking force, of one of the members transmitting the chucking force.

12. Chuck according to claim 11,
wherein the chucking-force measuring sensor is formed by a strain gauge.

13. Chuck according to claim 10,
wherein the chucking-force measuring sensor is formed directly as a force sensor.

14. Chuck according to claim 13,
wherein the force sensor is formed by a quartz crystal.

15. Chuck according to claim 10,
wherein the chucking-force measuring sensor is designed as a pressure sensor.

16. Chuck according to claim 1,
wherein the measuring device and/or the evaluating device has at least one transducer for converting the physical parameter measured with the at least one chucking-force measuring sensor into a chucking force and for storing the converted chucking force as an actual chucking force in at least one memory.

17. Chuck according to claim 1, wherein, furthermore, a pair of induction coils are provided for the non-contact transmission of energy to the at least one chucking device for the electrical supply of the measuring device and/or evaluating device.

18. Chuck according to claim 1,
wherein the at least one chucking device also has an identifier device for the clear identification of the chucking device.

19. Chuck according to claim 1,
wherein the chucking device has a top jaw and a chuck jaw detachably fastened thereto.
